(19) United States
(12) Patent Application Publication
(10) Pub. No.: US 2007/0192064 A1
(43) Pub. Date: Aug. 16, 2007

(54) Process fault analyzer and system, program and method thereof

(75) Inventors: Toshikazu Nakamura, Kawasaki-shi (JP); Shigeru Obayashi, Mishima-shi (JP); Kenichiro Hagiwara, Yokohama-shi (JP); Yoshikazu Aikawa, Tokyo-to (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/705,598

(22) Filed: Feb. 13, 2007

(30) Foreign Application Priority Data
Feb. 15, 2006 (JP) P2006-037588

(51) Int. Cl. G06F 19/00

(52) U.S. Cl. 702/185; 700/90; 700/95; 700/108; 700/174; 702/1; 702/33; 702/35; 702/127; 702/182; 702/183; 702/189

(57) ABSTRACT

A process fault analyzer, capable of analyzing fault caused due to a process performed by a plurality of process equipments, is provided. The analyzer includes: a plurality of process data storing units which store process data of the respective process equipments; a process data editing unit which calculates process characteristic quantity from various kinds of process data stored on the process data storing units; a plurality of process characteristic quantity data storing units which store process characteristic quantity of the respective process equipments calculated by the process data editing unit; a process characteristic quantity integration unit which accesses the process characteristic quantity data storing units, extracts process characteristic quantity of the same wafer, and integrates them; and a fault determination unit which determines presence or absence of fault according to the integrated process characteristic quantity data integrated by the process characteristic quantity integration unit.

This application claims priority from Japanese patent application JP2006-037588 filed Feb. 15, 2006. The entire content of the aforementioned application is incorporated herein by reference.

### BACKGROUND OF THE INVENTION

1. Field of the Invention

The present invention relates to a process fault analyzer which analyzes fault of a process for each object processed relating to a state of the process, and a system, a program and a method thereof.

2. Description of the Related Art

A manufacturing process of various products such as semiconductors and liquid crystal panels must be managed properly in order to improve manufacturing yield or to keep good yield of products.

A semiconductor device is manufactured through a semiconductor process including more than 100 steps, and manufactured using a plurality of complex semiconductor manufacturing devices. Therefore, many relationships between parameters indicating states of respective manufacturing devices (process equipments) and characteristics of semiconductor devices manufactured using the respective manufacturing devices are not understood clearly. On the other hand, in the semiconductor process, it is required that respective steps must always be managed strictly in order to improve the yield of semiconductor devices manufactured.

In order to solve such a problem, a modeling device disclosed in Japanese Patent Application Laid-Open No. 2004-186445 (Patent Document 1) collects in constant cycles a wide range of process data generated when the process is performed, and extracts process characteristic quantity from the process data obtained in time sequence. Then, the device combines process characteristic quantity data and test data for the same product, and analyzes the combined data by data mining, and creates a model of correlation between the process characteristic quantity and the result data in the semiconductor manufacturing process. With this model, it is possible to predict that under what condition of process characteristic quantity fault is caused, and further, to presume a part where fault is caused and its causes.

The invention disclosed in Patent Document 1 can predict fault caused due to the process carried out in one process equipment and presume the causes of fault. However, it cannot predict fault caused by interactions between processes carried out in multiple process equipments involved in manufacturing the product.

### SUMMARY OF THE INVENTION

It is an object of the present invention to provide a process fault analyzer, a process fault analyzing system and a program, capable of analyzing fault caused due to processes carried out by a plurality of manufacturing device (process equipments).

A process fault analyzer according to the present invention is a process fault analyzer for detecting fault in a process on a unit object according to process data obtained when the process is performed in a manufacturing system including a plurality of manufacturing devices. The analyzer includes: a process characteristic quantity integration unit which integrates process characteristic quantity data of respective manufacturing devices calculated from process data of the plurality of manufacturing devices, and generates integrated process characteristic quantity data; a fault analysis rule data storing unit which stores a fault analysis rule for performing fault analysis from the integrated process characteristic quantity data; a fault determination unit which performs fault analysis from the integrated process characteristic quantity data according to the fault analysis rule; and an output unit which outputs fault notifying information in the case of being determined as abnormal by the fault determination unit.

The analyzer may further include a process data storing unit which collects process data of respective manufacturing devices obtained when a plurality of manufacturing devices perform processes, and stores obtained process data in time sequence; and a process data editing unit which calculates process characteristic quantity data of respective manufacturing devices from process data of the respective manufacturing devices stored in the process data storing unit. The process characteristic quantity data, which is integration objects of the process integration unit, may include process characteristic quantity data of respective manufacturing devices acquired by the process data editing unit.

Further, the analyzer may be so configured that the process integration unit acquires process characteristic quantity data held by another process fault analyzer, and performs integration processing by using the process characteristic quantity data acquired.

Further, the analyzer may further include a display unit which outputs fault display information in the case of being determined as abnormal by the fault determination unit. The fault display information may be a name showing process data as a fault factor or a characteristic quantity thereof, and contribution rate data indicating which process data or characteristic quantity affects the fault how much.

A fault analyzing system according to the present invention is a process fault analyzing system for detecting fault in a process on a unit object according to process data obtained when the process is performed in a manufacturing system including a plurality of manufacturing devices. The system includes: a plurality of process fault analyzers which detect fault in a process on a unit object according to process data obtained when the process is performed. At least one of the plurality of process fault analyzers is the process fault analyzer which acquires process characteristic quantity data held by another process fault analyzer, and a process integration unit performed integration-processing by using the process characteristic quantity data acquired.

A program according to the present invention causes a computer to work as: a process characteristic quantity integration unit which integrates process characteristic quantity data for respective manufacturing devices calculated from process data of the plurality of manufacturing devices, and generates integrated process characteristic quantity data; a fault analysis rule data storing unit which stores a fault analysis rule for performing fault analysis from the integrated process characteristic quantity data; a fault determination unit which performs fault analysis from the integrated process characteristic quantity data according to the fault analysis rule; and an output unit which outputs fault notifying information in the case of being determined as abnormal by the fault determination unit.

In this case, a “process” includes a manufacturing process. Object products manufactured through the manufacturing process include semiconductors and FPD (flat panel displays: displays using liquid crystal, PDP, EL, FED, etc.). A “unit object ” may be an object which can be grasped by a general figure unit such as one semiconductor wafer or one glass substrate, or may be objects grasped by a group unit such as one lot of these products, or may be an object in which a unit thereof is a portion of a product such as a region provided on a large glass substrate. Output of fault notifying information includes various kinds of processing such as outputting to a display device, notifying by sending an email, and saving on a storing device.

Fault analysis includes determination of presence or absence of fault and identification of causes of fault. Causes of fault include a case of specifying specific parts and a case of specifying fault factors having high possibility of being abnormal. Fault factor analysis is so performed as to calculate contribution rate indicating which process characteristic quantity affects the fault how much, and those having high contribution rate are determined as fault factors.

In fault analysis, if y value, calculated from the following regression equation obtained by PLS method, is not less than the threshold, it is determined that fault is caused:
y=b0+b1*x1+b2*x2+ . . . +b(n−1)*x(n−1)+bn*xn

where x1, x2, . . . xn is variable: process characteristic quantity

b0, b1, b2, . . . bn is coefficient

(b1, b2, . . . bn is weighting of each variable)

Contribution rate of fault factor analysis may be a value calculated by multiplying a coefficient with a difference between an average value and observed value shown below.
b1(x1−X1),b2(x2−X2), . . . bn(xn−Xn)

where X1, X1, . . . Xn is an average value of each variable

Of course, determination of presence or absence of fault and fault factor analysis may be performed by using another algorithm.

In the present invention, fault analysis is performed based on integrated process characteristic quantity data in which process characteristic quantity data of respective manufacturing devices, calculated from process data of a plurality of manufacturing devices, are integrated. Therefore, it is possible to analyze fault caused due to processes carried out by the manufacturing devices (process equipments).

### BRIEF DESCRIPTION OF THE DRAWINGS

FIG. 1 is a diagram showing an example of a manufacturing system including a process fault analyzer which is a first embodiment of the present invention;

FIG. 2 is a diagram showing an example of the internal structure of the process fault analyzing device;

FIG. 3 is a diagram showing examples of data structures of various data to be processed by the process fault analyzer;

FIG. 4 is a diagram showing an example of the data structure of integrated process feature quantity data;

FIG. 5 is a diagram showing an example of the data structure of rule data stored on a fault analysis rule data memory;

FIG. 6 is a diagram showing a specific example of rule data to be stored on the fault analysis rule data memory;

FIG. 7 is a flowchart illustrating information to be displayed on a fault display device;

FIG. 8 is a flowchart illustrating a function of a fault determination unit;

FIG. 9 is a table showing an example of information to be displayed on the fault display unit;

FIG. 10 is a chart showing an example of information to be displayed on the fault display unit;

FIG. 11 is a table showing an example of information to be displayed on the fault display unit;

FIG. 12 is a table showing an example of information to be displayed on the fault display unit;

FIG. 13 is a diagram showing an example of a manufacturing system including a process fault analyzer which is a second embodiment of the present invention; and

FIG. 14 is a diagram showing an example of the internal structure of the process fault analyzer.

### DETAILED DESCRIPTION OF THE PREFERRED EMBODIMENTS

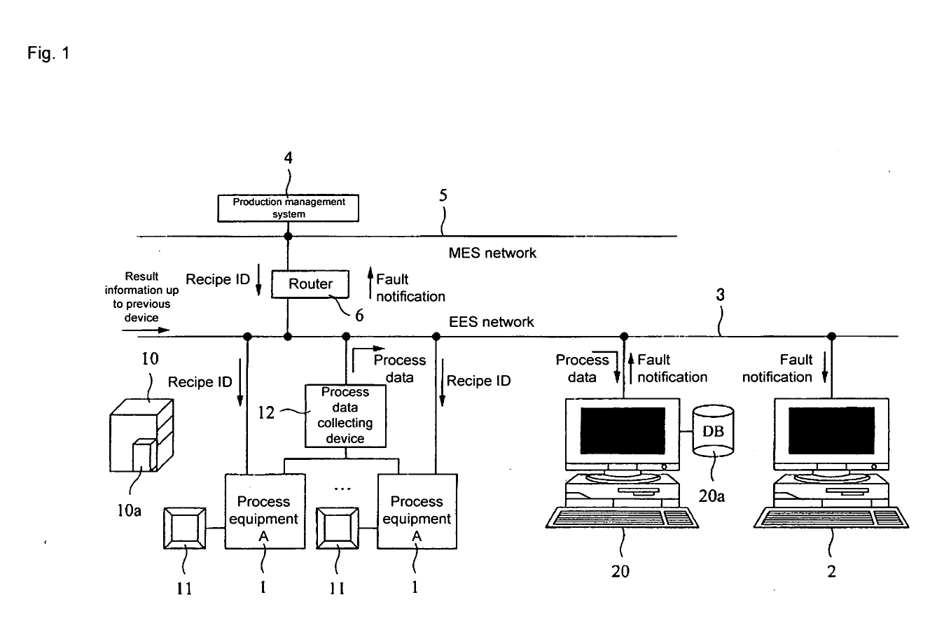

FIG. 1 shows a manufacturing system including a process fault analyzer which is a first embodiment of the present invention. The manufacturing system includes a plurality of process equipments, a process fault analyzer 20 and an fault display device 2. These devices are connected with one another over an EES (Equipment Engineering System) network 3. This is a network for devices to exchange process-related information, which is more detailed information than production management information, at a high speed. Although not shown, the EES network 3 is also connected with other process equipments and test devices used in stages before and after the process equipments 1. Further, the system also includes a production management system 4 including a MES (Manufacturing Execution System) and a MES network 5 for transmitting production management information connected with the production management system. The EES network 3 and the MES network 5 are connected via a router 6. The production management system 4 existing on the MES network 5 can access respective devices on the EES network 3 via the router 6.

The manufacturing system is to manufacture semiconductors or liquid crystal panels, for example. The process equipments 1 carry out a process for manufacturing semiconductors or the like (film formation processing and the like to a wafer). In a semiconductor manufacturing process or a liquid crystal panel manufacturing process, a prescribed number of wafers or glass substrates (hereinafter referred to as wafers) to be processed are set in a cassette, and are moved by a cassette unit, and prescribed processing is performed by the process equipments 1. The wafers of the prescribed number mounted in the cassette 10 constitute one rot.

In the semiconductor manufacturing system of the present embodiment, management must be performed for each wafer, so a product ID is allocated to each wafer. A product ID can be set by combining a rot ID and an identification number in the rot, for example. That is, if a rod ID is “0408251” and the number of pieces settable in the rod is one digit, a product ID of the second glass substrate in the rod (identification number in the rod is “2”) can be set to “0408252”, in which the identification number in the rod is added to the last digit.

Of course, it is acceptable that product IDs of all accommodated wafers are written on a tag 10a instead of the rod ID or together with the rod ID, and the process equipment 1 (process data collecting device 12) acquires all product IDs stored on the tag 10a. Alternatively, if only one wafer is set in the cassette 10, the ID written on the tag 10a can be used as the product ID as it is. In the case of performing analysis by a rot unit, it is not necessary to acquire a product ID and create a product ID based on a rot ID.

The RF-ID (radio frequency identification) tag 10a is attached to the cassette 10. The tag 10a is one which performs electromagnetic coupling with an RF-ID read/write head 11 linked to the process equipment 1 and to which data is written/read in a noncontacting manner. The tag 10a is also called as a data carrier. The tag 10a stores a rod ID and information such as outbound time from the device in the previous stage.

The process equipment 1 acquires a recipe ID from the production management system 4 over the MES network via the router 6. The process equipment 1 has a correspondence table of recipe ID and process to be carried out, and performs the process corresponding to the recipe ID acquired. Each of the multiple process equipments 1 has a device ID for identifying each device.

The multiple process equipments 1 are connected with the process data collecting device 12. The process data collecting device 12 is connected with the EES network 3. The process data collecting device 12 collects process data, which is information relating to the state of the process equipments 1, during a period that the process is carried out in the respective process equipments 1 or during standby. For example, process data includes voltage and current of the process equipments 1 when operated, and stay time from the outbound time from a process equipment 1 performing a process up to the inbound time to a process equipment 1 performing the next process. Further, if the process equipment 1 includes a plasma chamber and performs film formation to a wafer, the data includes pressure inside the plasma chamber, gas flow amount supplied to the plasma chamber, wafer temperature, and plasma light amount. The process equipment 1 includes a detector to detect such process data. Output from the detector is given to the process data collecting device 12.

The process data collecting device 12 collects the outbound time of the previous device and an inbound time to the process equipment 1 to which the wafer is currently set, read out from the tag 10a via the RF-ID read/write head 11. By calculating the difference between the outbound time and the inbound time, the stay time from the previous device can be obtained. Further, the RF-ID read/write head 11 writes the outbound time and the like onto the tag 10a when the wafer is delivered from the process equipment 1 as required.

The process data collecting device 12 has a communicating function. The process data collecting device 12 collects every process data generated in the process equipment 1, associates a product ID and a device ID with the collected process data, and outputs it to the EES network 3. The type of data to be collected is not limited to that described above, and more kinds of information can be acquired.

The process fault analyzer 20 is a general personal computer from the viewpoint of hardware. The respective functions of the present device are realized by application programs operated on an operating system such as Windows®.

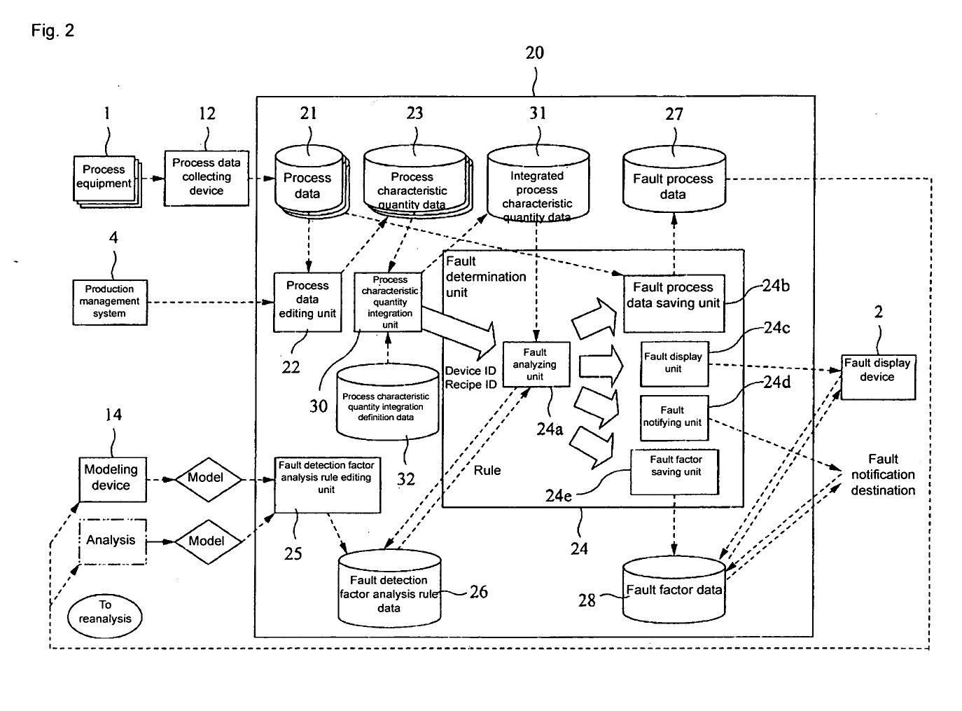

FIG. 2 shows the internal structure of the process fault analyzer 20. The process fault analyzer 20 includes: a plurality of process data storing units 21 which store process data for respective process equipments transmitted from the process data collecting device 12; a process data editing unit 22 which calculates process characteristic quantity from each kind of process data stored on each process data storing unit 21; a plurality of process data characteristic quantity data storing units 23 which store process characteristic quantity for respective process equipment calculated by the process data editing unit 22; a process characteristic quantity integration unit 30 which accesses the process characteristic quantity data storing units 23, and extracts and integrates the process characteristic quantity of the same wafer; an integrated data storing unit 31 which stores integrated process characteristic quantity data integrated by the process characteristic quantity integration unit 30; a fault determination unit 24 which determines presence or absence of fault based on the integrated process characteristic quantity data stored on the integrated data storing unit 31; an abnormal process data storing unit 27 which stores process data for a wafer determined as abnormal by the fault determination unit 24; an abnormal factor data storing unit 28 which stores abnormal factors determined as abnormal by the fault determination unit 24; a fault analysis rule data storing unit 26 which stores fault analysis rules used when the fault determination unit 24 performs determination processing; and an fault analysis rule editing unit 25 which accesses the fault analysis rule data storing unit 26 and performs addition and modification of fault analysis rules.

Each storing unit may be provided to an external storing device (database 20a) of the process fault analyzer 20 or to an internal storing device. If a plurality of storing units of the same kind exist like the process data storing units 21, one storing device may be used physically.

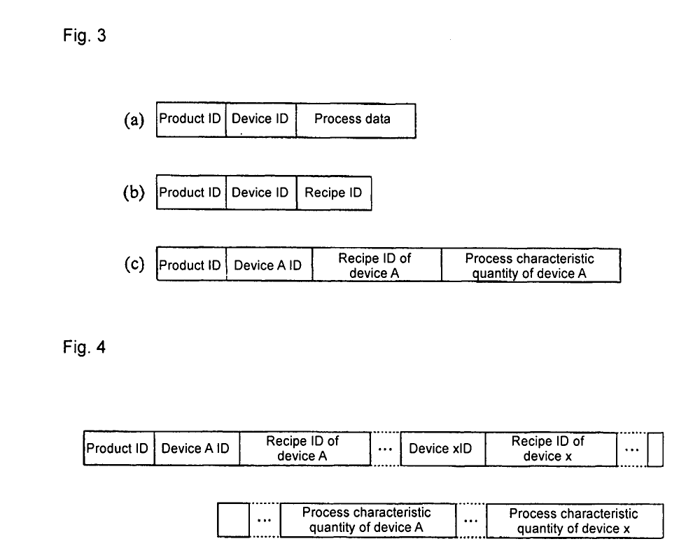

As shown in FIG. 3A, process data stored on the process data storing unit 21 is associated with a product ID and a device ID. Process data includes date and time information (date+time) that the process data is collected, in addition to various kinds of process data collected by the process data collecting device 12. The process data storing unit 21 for each process equipment stores process data for each product ID in time sequence according to date and time information.

The process data storing unit 21 consists of a temporary storing means such as a ring buffer, and is so configured that process data is deleted (new process data is overwritten) at prescribed timing after the process is completed.

The process data editing unit 22 calls process data in time sequence stored on the process data storing units 21, and calculates the process characteristic quantity for each product ID. The process characteristic quantity is not limited to that calculated from values of process data such as a peak value of process data, the total amount, and an average value of the same product ID, but also includes various types such as a time exceeding the threshold to which a value of process data is set.

The process data editing unit 22 acquires a recipe ID outputted from the production management system 4, together with a product ID and a device ID. A recipe is a set of instructions, settings and parameters with respect to a process equipment previously determined. Multiple recipes are provided depending on processing objects, steps and devices, and are managed by the production management system 4. Each recipe is provided with a recipe ID. A recipe with respect to a wafer to be processed by each process equipment 1 is identified by a device ID, a product ID and a recipe ID.

The process data editing unit 22 acquires a set of product ID, device ID and recipe ID shown in FIG. 3B. First, the process data editing unit 22 accesses the production management system (MES) 4, and searches for the corresponding recipe ID by using the product ID of the wafer which is the analysis object and the device ID specifying the process equipment 1 as the key. Then, the process data editing unit 22 acquires the searched recipe ID directly from the production management system 4 or via the process data collecting device 12. In the case of acquiring via the process data collecting device 12, the process data collecting device 12 may acquire the recipe ID of the process in progress from the production management system (MES) 4, and provide it to the process fault analyzer 20 together with the device ID of the process equipment 1 and the process data.

The process data editing unit 22 combines the calculated process characteristic quantity data and the acquired recipe ID by using the product ID and the device ID as the key, and stores the combined data on the process characteristic quantity data storing unit 23 for the corresponding device ID. Therefore, the data structure of the process characteristic quantity data storing unit 23 becomes the one shown in FIG. 3C.

The process characteristic quantity integration unit 30 accesses the process characteristic quantity database 23, and extracts the process characteristic quantity of the same product ID according to the process characteristic quantity integration definition data previously defined, and integrates them. The integrated process characteristic quantity data has such a data structure that the product ID, the device ID of the process equipment involved in manufacturing the wafer, and the process characteristic quantity data generated from the process equipment are associated; as shown in FIG. 4. The integrated process characteristic quantity data is stored on the integrated data storing unit 31. Further, when the process characteristic quantity integration unit 30 performs, all of the process characteristic quantity for the wafer, which is the processing object, have not always been generated. To cope with it, the process characteristic quantity integration unit 30 determines whether the integrated process characteristic quantity data corresponding to the product ID of the extracted process characteristic quantity data has already been registered in the integrated data storing unit 31. If it is not registered, the process characteristic quantity integration unit 30 registers the integrated process characteristic quantity data as new data, and if it is registered, it reads out the registered integrated process characteristic quantity data, and combines the device ID and the process characteristic quantity of the process characteristic quantity data.

The process characteristic quantity integration definition data is registered in the process characteristic quantity integration definition data storing unit 32. The process characteristic quantity integration definition data may be one specifically describing a combination of product ID and device ID, or the general rule described above, that is, “to integrate data of the same product ID, and newly register if not registered in the integrated data storing unit 31, and combine with the existing integrated process characteristic quantity data if registered”.

The fault analysis rule editing unit 25 acquires a model obtained through analysis performed by using a modeling device 14 or by humans, defines fault analysis rules, and stores them on the fault analysis rule data storing unit 26. As the modeling device 14, one using data mining, disclosed in Japanese Patent Application Laid-Open No. 2004-186445, can be used for example. Data mining is a method of extracting rules and patterns from a large database. As specific methods thereof, a method called decision tree analysis and a method called regression tree analysis are known.

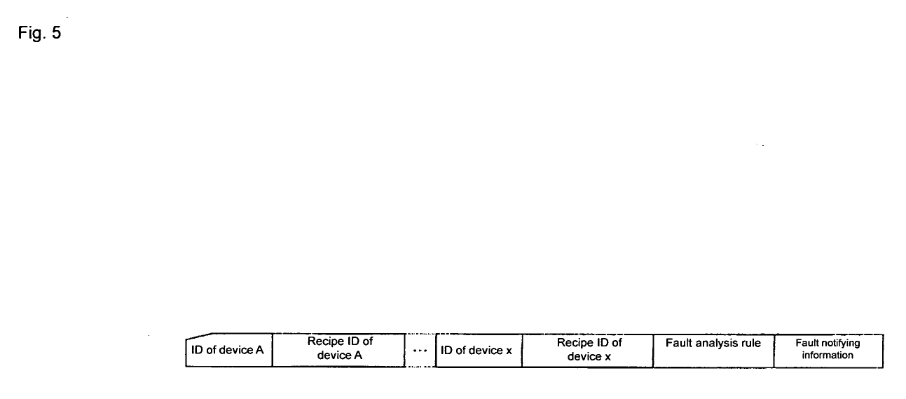

Further, the fault analysis rule editing unit 25 also registers fault notifying information corresponding to fault analysis rules. Thereby, the data structure of the fault analysis rule data storing unit 26 becomes a table structure in which a device ID of each process equipment, a recipe ID of each process equipment, fault analysis rules and fault notifying information are associated, as shown in FIG. 5.

Fault notifying information includes information specifying an output destination such as a fault display device 2 displaying the result determined based on the fault analysis rules and a notification destination to which the determination result is notified, and specific contents of the notification. A notified party may be an email address of a person in charge. Both of the fault display device 2 and the notification destination may be registered, or one of them may be registered. In the case of setting multiple output destinations, they may be classified by fault levels calculated by the determination or by abnormal parts, which are allocated corresponding to the classification. A plurality of fault display devices, notification destinations and notified contents may be designated to one classification. As fault analysis rules, methods such as a linear regression, a determination tree, Mahalanobis distance, a principal component analysis, a moving principal component analysis, and DISSIM may be used.

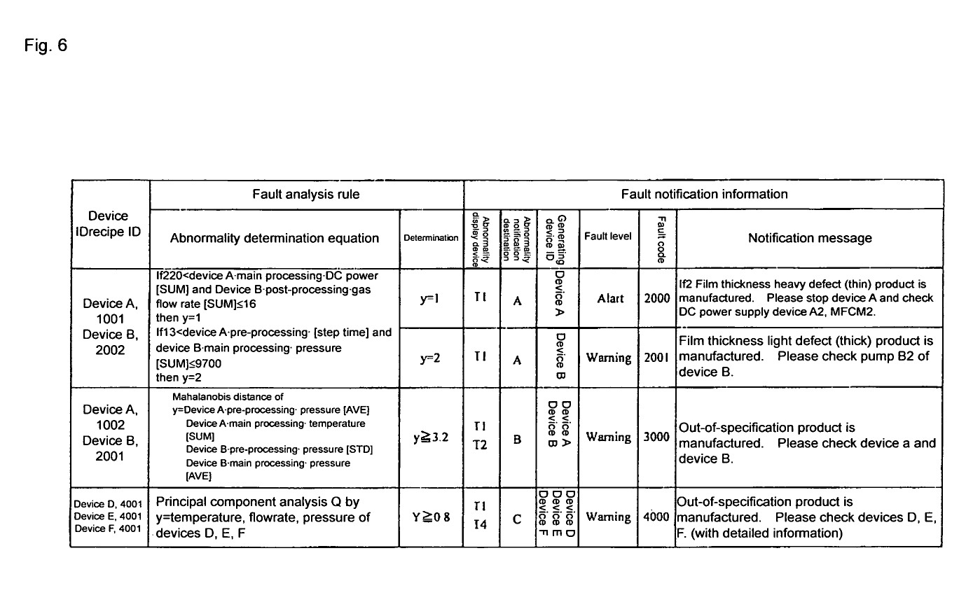

FIG. 6 shows specific examples of data (recipe ID, device ID, fault analysis rules, fault notifying information) stored on the fault analysis rule data storing unit 26. As shown, the fault analysis rules include fault determination equations for computation processing based on process characteristic quantity, and determination conditions for determining whether a value (y) calculated by a fault determination equation causes fault.

The fault analysis rule is a rule to perform fault detection and fault factor analysis from process characteristic quantity. Fault detection is to determine presence or absence of fault. In the example shown in FIG. 6, the top two fault analysis rules are rules for performing fault detection for the combination of devices A and B. In these rules, abnormal parts are also identified specifically. The bottom fault analysis rule is a rule to perform fault detection for a combination of devices D, E and F. However, this fault analysis rule is to make a determination collectively from a plurality of fault factors, so it cannot specify the abnormal parts.

Fault factor analysis is to obtain abnormal factor data. Abnormal factor data includes name and contribution rate data indicating process data or the characteristic quantity thereof. Contribution rate data indicates which process data or its characteristic quantity affects the fault how much. As the value of the contribution rate data is larger, the level of the effect on the fault is higher. That is, it is said that the possibility causing the fault is large. Pieces of fault factor data including contribution rate data having the top N numbers (e.g., 5) of values calculated by the fault factor analysis are extracted. Based on the fault factor data extracted, it is understood that which process data should be checked when coping with the detected fault.

In the present embodiment, contribution rate for determining fault factor data is calculated by a regression equation obtained by a PLS (Partial Least Squares) method. The regression equation obtained by the PLS method is as follows:
y=b0+b1*x1+b2*X2+ . . . +b(n−1)*x(n−1)+bn*xn

In the equation above, each of x1, x2, . . . xn indicates process characteristic quantity, and each of b0, b1, b2, . . . bn indicates coefficient. b1, b2, . . . bn indicates weighting of each process characteristic quantity. When the y value calculated by the regression equation exceeds the threshold, it is determined as abnormal. Fault detection using the PLS method is disclosed in Japanese Patent Application Laid-Open No. 2004-349419, paragraphs [0080] to [0093], for example.

In the present embodiment, contribution rate of each process characteristic quantity is obtained by using the PLS method. First, a PLS prediction value, when each variable (x1, x2, . . . xn) shows an average value, is assumed to be Y. Then, it is estimated that how much each term contributes to the size of y−Y which is the difference from y obtained by assigning the process characteristic quantity actually obtained to each variable. In other words, assuming that the average value of each variable is X1, X2, . . . Xn, the value of each term becomes as follows:
b1(x1−X1),b2(x2−X2), . . . bn(xn−Xn)

In this way, a value of each term which is a value obtained by multiplying the difference between the average value and the observed value with a coefficient is set as contribution rate data of each process characteristic quantity.

The factor analysis using the contribution rate corresponds to recipe ID=4001 in FIG. 6. With the fault analysis rule of the recipe ID=4001, a plurality of abnormal factors can be listed up, although specific abnormal parts cannot be specified. “Temperature”, “FlowRate” and “Pressure” are process characteristic quantity obtained from the temperature, the gas flow rate and the gas pressure, which are process data, respectively.

In the present embodiment, fault determination is performed based on integrated process characteristic quantity data in which process characteristic quantity of multiple process equipments are integrated. Therefore, as a result of performing factor analysis, it is possible to specify a process equipment in which fault may be caused with high possibility and to specify which process characteristic quantity of the process equipment involves a problem.

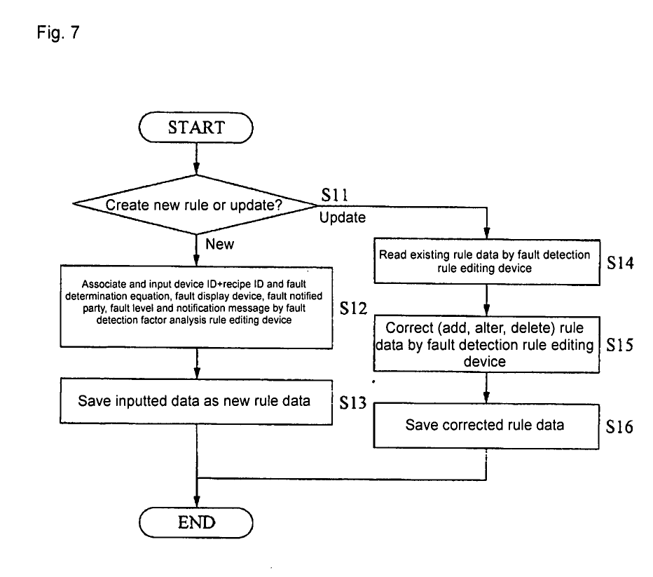

The specific processing function of the fault analysis rule editing unit 25 is to carry out the flowchart shown in FIG. 7. First, the fault analysis rule editing unit 25 determines whether it is creation of new data or updating (S11). This determination is so performed that the fault analysis rule editing unit 25 displays an input screen including a “new data” button and an “update” button on the display device of a PC constituting the process fault analyzer 20, and recognizes which button is selected.

In the case of creating new data, the fault analysis rule editing unit 25 associates a device ID of each process equipment, a recipe ID of each process equipment, fault analysis rules and fault notifying information (S12). Specifically, association can be performed by the fault analysis rule editing unit 25 through acquisition of a device ID, a recipe ID, a model and fault notifying information provided by the modeling device 14. Fault analysis rules are specified by the model. If there is an unregistered item in the fault notifying information provided by the model creating device 14, the fault analysis rule editing unit 25 displays the acquired information on the display device. For example, the display mode of the display device is a table form as shown in FIG. 6, and an unregistered item is kept blank. A user operates an input device of a PC constituting the process fault analyzer 20 so as to input the unregistered item. The fault analysis rule editing unit 25 associates the inputted information with information obtained from the modeling device 14. The unregistered items include fault notification destination and information for specifying a fault display device displaying fault information, which can be set by the user. Of course, the modeling device 14 may create all items of fault notifying information. A Model and the like created by the modeling device 14 may be provided online to the fault analysis rule editing unit 25, or may be provided offline such that an operator inputs a model or the like.

The fault analysis rule editing unit 25 carries out the processing step S12 so as to save the associated data on the fault analysis rule data storing unit 26 as new rule data, and ends processing of creating new data (S13).

In the case of updating, the fault analysis rule editing unit 25 accesses the fault analysis rule data storing unit 26, and reads out the existing rule data (S14). For performing the readout, if the recipe ID or the like of the editing object is known, the corresponding rule data is read out by searching for it with the recipe ID or the like as the key. Alternatively, all pieces of data can be read out. In the case of reading out all pieces of rule data, the fault analysis rule editing unit 25 outputs it on the display device in a table format as shown in FIG. 6, for example.

Next, the fault analysis rule editing unit 25 performs correaction (addition, alteration and deletion) of the readout rule data (S15), saves the corrected rule data on the fault analysis rule data storing unit 26 (S16), and ends the updating.

The fault determination unit 24 includes a fault analyzing unit 24a, a fault process data saving unit 24b, a fault display unit 24c, a fault notifying unit 24d, and a fault factor saving unit 24e. The fault analyzing unit 24a performs fault determination by using the fault analysis rules stored on the fault analysis rule data storing unit 26, in accordance with the integrated process characteristic quantity data readout from the integrated data storing unit 31. Fault determination carried out by the fault analyzing unit 24a includes presence or absence of fault and analysis of abnormal factors.

The fault process data saving unit 24b read outs process data for the wafer determined as abnormal, from the process data storing unit 21 when fault is detected by the fault analyzing unit 24a, and saves it on the fault process data storing unit 25 as fault process data. At this time, the fault determination result (y value) may be associated and registered.

The fault display unit 24c outputs a fault message to the designated fault display device when fault is detected by the fault determination unit 24a. A fault message to be outputted is stored on the fault analysis rule data storing unit 26. Further, when fault factor analysis is performed, detailed data such as contribution rate is also outputted together.

The fault information unit 24d outputs a fault message, when fault is detected by the fault analyzing unit 24a, by means of a designated method to the designated fault notification destination. As an example, the fault notifying unit 24d sends an email to the designated address. A fault message to be outputted is stored on the fault analysis rule data storing unit 26. Further, when fault factor analysis is performed, detailed data such as contribution rate is also outputted together.

If fault factor information such as contribution rate exists as a result of fault determination by the fault analyzing unit 24a, the fault factor saving unit 24e saves the information on the fault factor data storing unit 28 as fault factor data.

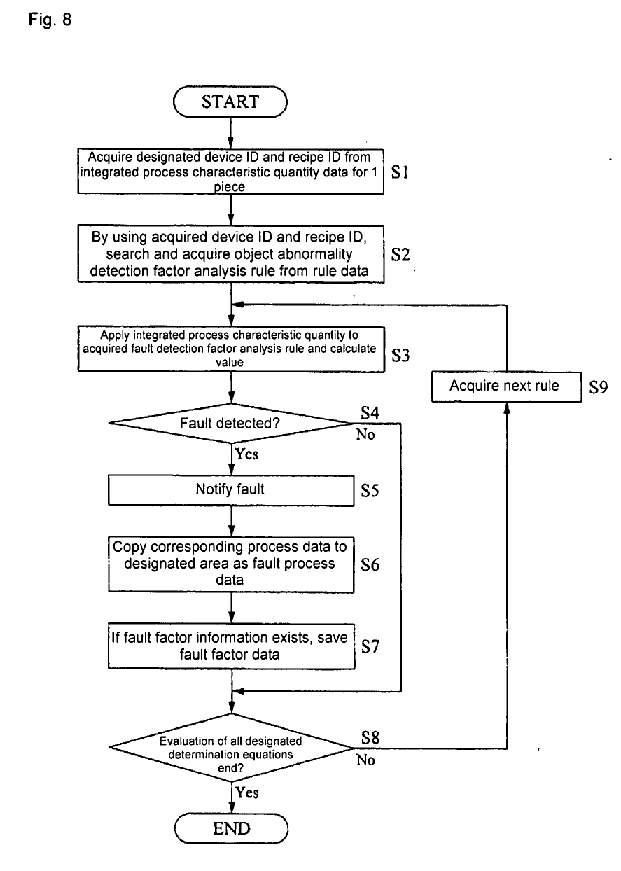

The specific processing function of the abnormal determination unit 24 is configured like the flowchart shown in FIG. 8. First, the fault analyzing unit 24a accesses the integrated data storing unit 31, extracts integrated process characteristic quantity data for one product ID by using one product ID as the key, and obtains the recipe information thereof (S1).

The fault analyzing unit 24a accesses the fault analysis rule data storing unit 26, and obtains a fault analysis rule corresponding to the recipe ID and the device ID obtained (S2). The fault analyzing unit 24a assigns the integrated process characteristic quantity data to the fault determination equation of the fault analysis rule obtained, and calculates the y value (S3).

The fault analyzing unit 24a determines presence or absence of fault based on the determination conditions (S4). For example, in the case of recipe ID=1001, four determination conditions exist, so when the processing step S3 is carried out and a y value is calculated from the fault determination equation, it is checked sequentially that to which determination condition the y value coincides. Further, in the case of recipe ID=1004, a principle component analysis is performed, and if the y value becomes 0.8 or more of the determination condition, the contribution rate data included in each fault factor data is also confirmed, and fault factor data that the value of contribution rate data corresponds to the top N numbers is extracted. The value of N is set arbitrarily, which may be 5, or all pieces of fault factor data may be extracted (N=n).

When fault is detected (Yes in S4), the fault is notified according to fault notifying information corresponding to the determination conditions (S5). Specifically, the fault display unit 24c outputs a message to the fault display device 2 previously set, and the fault notification unit 24d notifies to the fault notification destination previously by sending an email or the like. The content to be notified includes occurrence date and time information and a fault notification ID, in addition to fault display information stored on the fault analysis rule data storing unit 26 and the recipe ID.

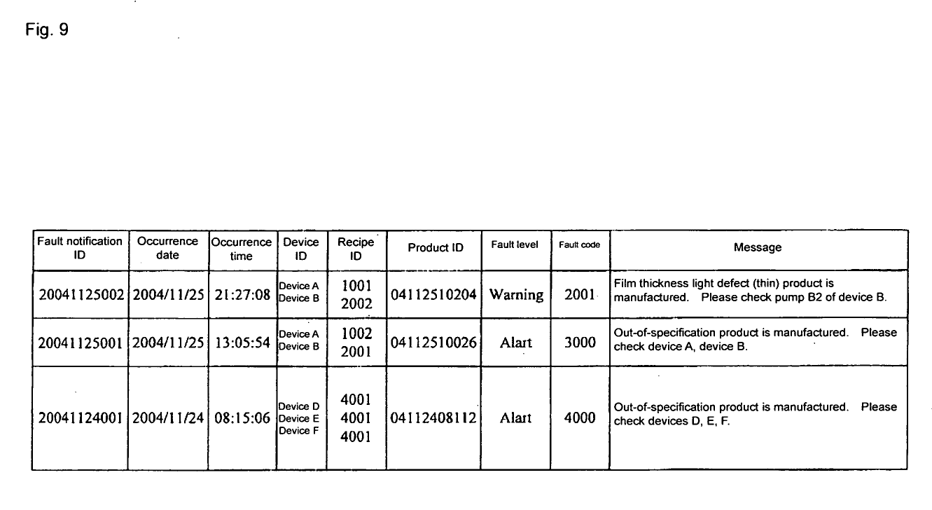

As a display example to be displayed on the fault display device 2 based on the fault notification outputted from the fault display unit 24c, a table format may be used as shown in FIG. 9. FIG. 9 shows an example indicating a list of multiple fault notifications. Actually, fault notifications are transmitted from the fault display unit 24c in real time, so transmitted information is added to the list sequentially and displayed. Of course, the fault display device 2 may store fault notifying information and the like transmitted on a display device and display them later as a list. Further, although not shown, contents to be outputted from the fault display unit 24c and the fault notifying unit 24d may be stored on a database provided to the process fault analyzer 20 and manage them.

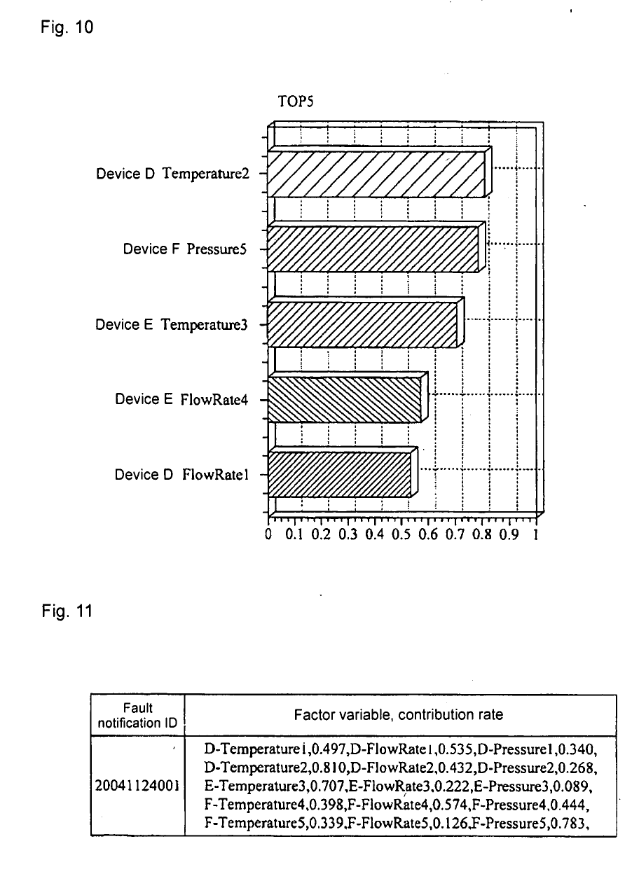

Further, as shown in FIG. 9, information outputted from the fault display unit 24c includes information of presence or absence of fault factors. In FIG. 9, in the case of including factor information such as fault information ID=20041124001, factor variable and contribution rate are also outputted. Therefore, based on the factor variable and contribution rate obtained, the fault display device 2 displays the top n pieces (5 in this example) of data in a bar chart for example as shown in FIG. 10. Thereby, a user can understand at a glance which process characteristic quantity of which process equipment has a high possibility of causing the fault. Of course, a display mode of factor variable and contribution rate is not limited to a bar chart, but can take various display modes such as a circular chart and other charts, or a text display in a table format as shown in FIG. 11.

Further, the fault process data saving unit 24b accesses the process data storing unit 21 by using the product ID determined abnormal as the key, obtains the corresponding process data, and stored it on the fault process data storing unit 27 as fault process data (S6).

The fault process data stored on the fault process data storing unit 27 is read out by the modeling device 14, and analyzed therein, and used as information to create a new model or to modify the existing model. Further, such an analysis is not limited to one automatically performed by the modeling device 14, but one performed by a human so as to create a new model. A model created by such a reanalysis is stored on the fault analysis rule data storing unit 26 via the fault analysis rule editing unit 25, and used for subsequent fault determination.

In this way, process data for a wafer determined as abnormal can be stored on the fault process data storing unit 27 as abnormal process data. Therefore, only data at the time of abnormal, among raw data of process data of enormous data amount, can be saved. This enables to save the capacity of a physical storing device such as a hard disk.

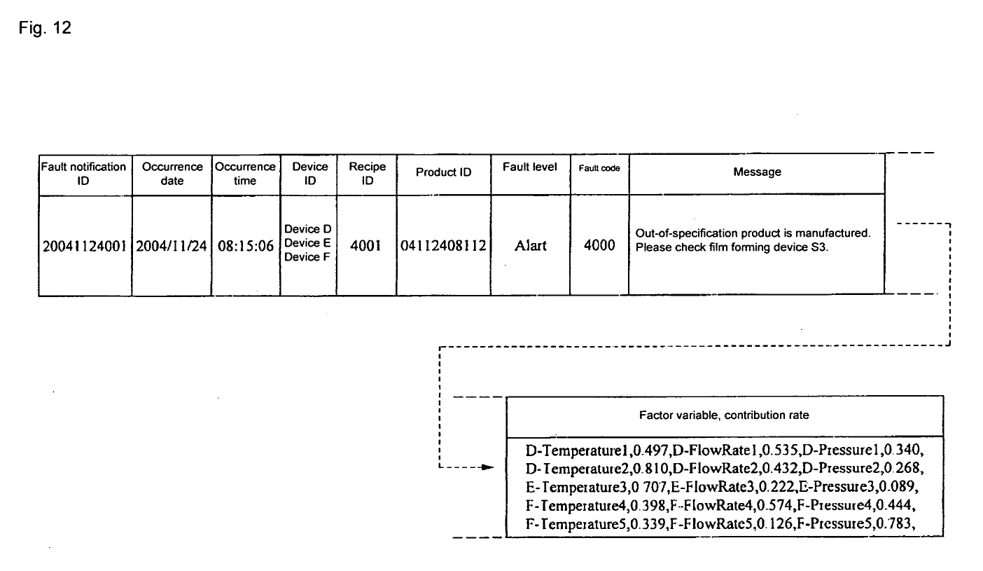

After performing the processing step S6, if there is fault factor information, the fault factor saving unit 24e performs processing to save the fault factor data on the fault factor data storing unit 28 (S7). The data structure of fault factor data to be saved on the fault factor data storing unit 28 is one shown in FIG. 12. As shown, it consists of a table in which an fault notification ID, occurrence date, occurrence time, a device ID where fault is caused, a recipe ID, a product ID, an fault level, a fault code, a message, factor variables and contribution rates are associated. A device ID, a recipe ID, a product ID, a fault level, a fault code and a message are generated from fault notifying information stored on the fault analysis rule data storing unit, and occurrence date and occurrence time are generated based on the internal timer held by the device, and a fault notification ID is generated by combining the occurrence date and a record number of three digits at the occurrence date by the fault analyzing unit 24a. The example of FIG. 12 shows a fault notification generated first on Nov. 24, 2004. For factor variables and contribution rates, the top N pieces (including N=n), among contribution rates of the respective factor variables calculated by the fault analyzing unit 24a, are extracted and registered on the fault factor data storing unit 28 by being set with factor variables. The fault factor data stored on the fault factor data storing unit 28 can be searched from the fault display device 2 and from an external device such as the modeling device 14.

The fault analyzing unit 24a determines whether evaluation of all determination equations included in the fault analysis rules have been completed (S8). If not (NO in S8), the fault analyzing unit 24a acquires the next determination equation (S9), and repeats the processing step S3 and after, until determination by using all determination equations has been completed.

In the embodiment above, one process data collecting device 12 collects process data of multiple process equipments. However, the present invention is not limited to this configuration. It is acceptable that each process equipment is connected with each process data collecting device such that one process data collecting device collects process data of one process equipment. In such a case, a process data collecting device may be incorporated in a process equipment, or provided as an external device.

The provided position of the fault display device 2 is not limited to the EES network 3. It may be connected with the MES network 5, or a further external network. The fault display device 2 and the process fault analyzer 20 may be configured in the same PC.

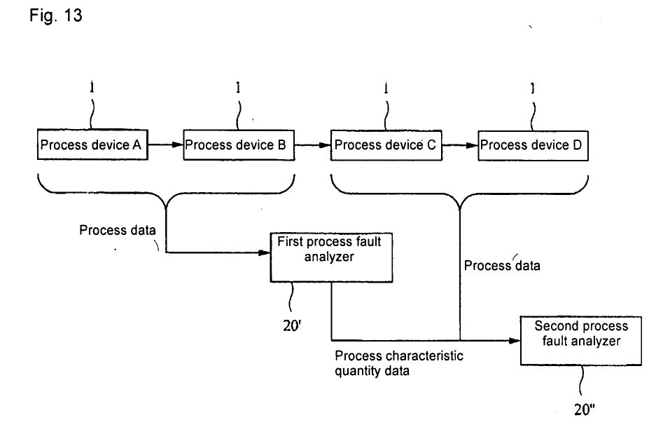

FIG. 13 shows a second embodiment of the present invention. In the present embodiment, a plurality of process fault analyzers are provided. In this example, process data of two process equipments 1 (A, B) are provided to a first process fault analyzer 20′, and process data of the other two process equipments 1 (C, D) are provided to a second process fault analyzer 20″. Further, the present embodiment is so adapted that process characteristic quantity data generated by the first process fault analyzer 20′ is provided to the second process fault analyzer 20″, and stored on the process characteristic quantity data storing unit of the second process fault analyzer 20″. Note that in FIG. 13, a process data collecting device is omitted.

Thereby, the first process fault analyzer 20′ generates respective pieces of process characteristic quantity data from pieces of process data collected from the two process equipments, that is, the process equipment A and the process equipment B, and based on the respective pieces of process characteristic quantity data, generates the integrated process characteristic quantity data. Then, the first process fault analyzer 20′ performs fault analysis based on the integrated process characteristic quantity data generated. The first process fault analyzer 20′ transmits the generated process characteristic quantity data for the process equipment A and the process equipment B to the second process fault analyzer 20″.

The second process fault analyzer 20″ stores the process characteristic quantity data for the process equipment A and the process equipment B acquired from the first process fault analyzer 20′ on the process characteristic quantity data storing unit 23. The second process fault analyzer 20″ generates pieces of process characteristic quantity data from the pieces of process data collected from the two process equipments, that is, the process equipment C and the process equipment D, respectively, and stores them on the process characteristic quantity data storing unit 23. The process characteristic quantity integration unit 30 of the second process fault analyzer 20″ generates integrated process characteristic quantity data based on the process characteristic quantity data for the four process equipments. Thereby, the second process fault analyzer 20″ can perform fault analysis based on the integrated process characteristic quantity data in which the pieces of process characteristic quantity data of the four process equipments are integrated. For the pieces of process characteristic quantity data for the process equipment A and the process equipment B, those generated by the first process fault analyzer 20′ are used. Therefore, it is not needed to regenerate the process characteristic quantity data by the second process fault analyzer 20″, which reduces the load.

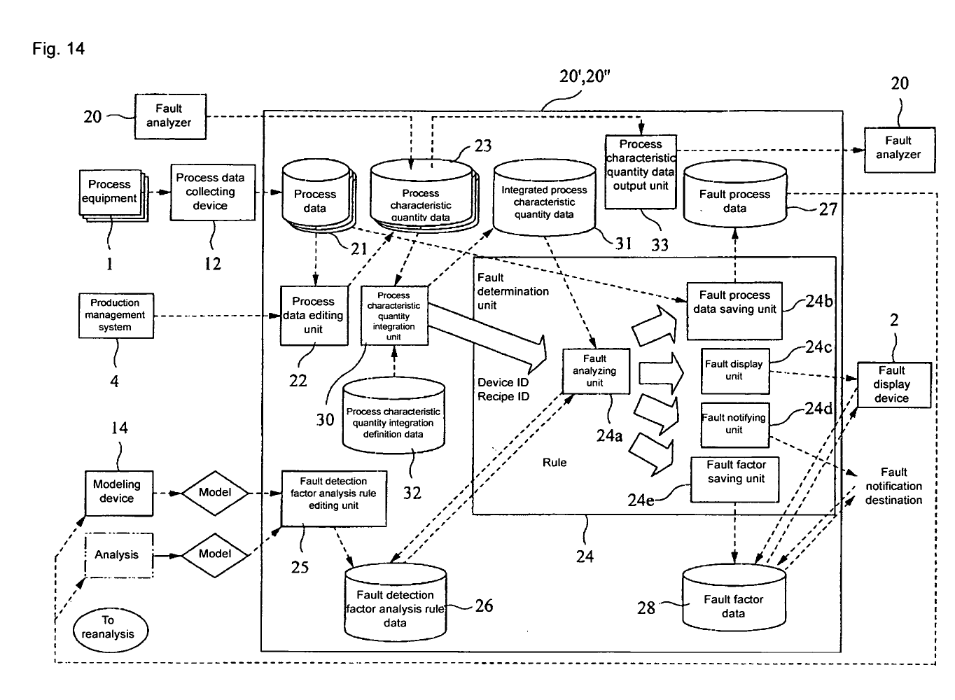

FIG. 14 is a block diagram showing the internal structure of the process fault analyzers 20′ and 20″ used in the present embodiment. As shown in FIG. 14, each of the process fault analyzers 20′ and 20″ stores process characteristic quantity data transmitted from another process fault analyzer 20 on the process characteristic quantity data storing unit 23. Further, each of the process fault analyzers 20′ and 20″ has a process characteristic quantity data output unit 33 which reads out process characteristic quantity data of a prescribed process equipment from the process characteristic quantity data storing unit 23 and outputs it to another process fault analyzer 20. The process characteristic quantity data output unit 33 has information that data of which process equipment is transmitted to which process fault analyzer, among pieces of process characteristic quantity data held by it, and carries out output processing based on the information.

The present embodiment is so adapted that process characteristic quantity data generated by another process fault analyzer is temporarily stored on the process characteristic quantity data storing unit of oneself. However, the present invention is not limited to this configuration. For example, it is also acceptable that the process characteristic quantity data integration unit 31 accesses the process characteristic quantity data storing unit of another process fault analyzer, reads out necessary process characteristic quantity data stored thereon, and integrates it with the process characteristic quantity data held by it.

By using process characteristic quantity data generated by another process fault analyzer, it is possible to incorporate one or more process fault analyzers in a process equipment. For example, the first process fault analyzer 20′ is incorporated in a process equipment, and the second process fault analyzer 20″ is connected with the EES network 3. The first process fault analyzer 20′ performs fault determination based on process data from the process equipment on which it is mounted, and provides the second process fault analyzer 20″ with the process characteristic quantity data of the process equipment. The second process fault analyzer 20″ integrates the acquired process characteristic quantity data and process characteristic quantity data generated from process data of a process equipment acquired over the EES network 3, and performs fault determination based on the integrated process characteristic quantity data obtained. Of course, the first process fault analyzer 20′ incorporated in the process equipment may acquire process characteristic quantity data from another process fault analyzer and perform fault determination.

What is claimed is:

1. A process fault analyzer for detecting fault in a process on a unit object according to process data obtained when the process is performed in a manufacturing system including a plurality of manufacturing devices, comprising:
a process characteristic quantity integration unit which integrates process characteristic quantity data for respective manufacturing devices calculated from process data of the plurality of manufacturing devices, and generates integrated process characteristic quantity data;
a fault analysis rule data storing unit which stores a fault analysis rule for performing fault analysis from the integrated process characteristic quantity data;
a fault determination unit which performs fault analysis from the integrated process characteristic quantity data according to the fault analysis rule; and
an output unit which outputs fault notifying information in a case of being determined as abnormal by the fault determination unit.

2. The process fault analyzer according to claim 1, further comprising:
a process data storing unit which collects process data of respective manufacturing devices obtained when a plurality of manufacturing devices perform a process, and stores obtained process data in time sequence; and
a process data editing unit which calculates process characteristic quantity data of the respective manufacturing devices from process data of the respective manufacturing devices stored in the process data storing unit, wherein
the process characteristic quantity data, which is integration object of the process integration unit, includes process characteristic quantity data of the respective manufacturing devices calculated by the process data editing unit.

3. The process fault analyzer according to claim 1, wherein the process integration unit acquires process characteristic quantity data held by another process fault analyzer, and performs integration processing by using the process characteristic quantity data acquired.

4. The process fault analyzer according to claim 1, further comprising a display unit which outputs fault display information in a case of being determined as abnormal by the fault determination unit, wherein
the fault display information includes a name showing process data as a fault factor or a characteristic quantity thereof, and contribution rate data indicating which process data or characteristic quantity affects the fault how much.

5. The process fault analyzer according to claim 3, further comprising a display unit which outputs fault display information in a case of being determined as abnormal by the fault determination unit, wherein
the fault display information includes a name showing process data as a fault factor or a characteristic quantity thereof, and contribution rate data indicating which process data or characteristic quantity affects the fault how much.

6. A process fault analyzing system for detecting fault in a process on a unit basis according to process data obtained when the process is performed in a manufacturing system including a plurality of manufacturing devices, the system comprising:
a plurality of process fault analyzers which detect fault in a process on an unit object according to process data obtained when the process is performed, wherein
at least one of the plurality of process fault analyzers is the process fault analyzer according to claim 3.

7. A process fault analyzing system for detecting fault in a process on a unit basis according to process data obtained when the process is performed in a manufacturing system including a plurality of manufacturing devices, the system comprising:
a plurality of process fault analyzers which detect fault in a process on an unit object according to process data obtained when the process is performed, wherein
at least one of the plurality of process fault analyzers is the process fault analyzer according to claim 5.

8. A program for causing a computer to work as:
a process characteristic quantity integration unit which integrates process characteristic quantity data for respective manufacturing devices calculated from process data of a plurality of manufacturing devices, and generates integrated process characteristic quantity data;
a fault analysis rule data storing unit which stores a fault analysis rule for performing fault analysis from the integrated process characteristic quantity data;
a fault determination unit which performs fault analysis from the integrated process characteristic quantity data according to the fault analysis rule; and
an output unit which outputs fault notifying information in a case of being determined as abnormal by the fault determination unit.

9. A process fault analyzing method to detect fault in a process on an unit object according to process data obtained when the process is performed in a manufacturing system including a plurality of manufacturing devices, comprising the steps of:
integrating process characteristic quantity data of respective manufacturing devices calculated from process data of the plurality of manufacturing devices, and generating integrated process characteristic quantity data;
performing fault analysis from the integrated process characteristic quantity data according to a fault analysis rule for performing fault analysis from the integrated process characteristic quantity data; and
outputting fault notifying information in a case of being determined as abnormal by an fault determination unit.
